(19) United States
(12) Patent Application Publication
(10) Pub. No.: US 2026/0298787 A1
(43) Pub. Date: Oct. 1, 2026

(54) DYNAMIC TESTING SYSTEM CONTROL VALVE ADAPTER

(71) Applicant: ILLINOIS TOOL WORKS INC., Glenview, IL (US)

(72) Inventors: James M. Hennen, Plymouth, MN (US); Alan Paumen, Norwood Young America, MN (US); Thomas Byron, Cottage Grove, MN (US); Stephen Zachman, St. Louis Park, MN (US)

(21) Appl. No.: 19/576,310

(22) Filed: Mar. 24, 2026

Related U.S. Application Data
(60) Provisional application No. 63/778,139, filed on Mar. 26, 2025.

(51) Int. Cl. G01N 3/10; F15B 9/09

(52) U.S. Cl. CPC G01N 3/10; F15B 9/09; G01N 2203/0048

(57) ABSTRACT

An adapter for connecting to a test station control valve includes a control input, a control output, a power input, and a first power output. The control input is configured to receive a valve control signal, and the control output is coupled to the control input and is configured to connect to a valve control input of the control valve. The power input is configured to receive electrical power from a power source, and the first power output is coupled to the power input and is configured to connect to a valve power input of the control valve. The adapter also includes a fuse connected in line between the power input and the first power output, a position input configured to connect to a valve position output of the control valve and a position output coupled to the position input, and/or an enable/disable input and an enable/disable output.

### CROSS-REFERENCE TO RELATED APPLICATIONS

This application claims the benefit of priority from U.S. Provisional Patent Application No. 63/778,139 filed March 26, 2025 for “Dynamic Testing System Control Valve Adapter,” the content of which is hereby incorporated by reference.

### FIELD

Embodiments of the present disclosure generally relate to test stations of dynamic testing systems and, more particularly, to speed control of a hydraulic actuator of a test station.

### BACKGROUND

Dynamic testing systems, such as those developed by MTS Systems Corporation, include test stations that perform various tests through the application of loads and displacements to a test subject using hydraulic actuators. Test stations may include, for example, a vehicle testing station that applies simulated driving conditions to a mobile vehicle, or a building testing station that applies simulated seismic activity to a building.

The actuators of the test stations are driven by hydraulic fluid flows. The actuations performed by each actuator are controlled using a control valve (e.g., proportional control valve) that regulates the flow rate and direction of the hydraulic fluid flow through the actuator. Control signals from the test station and power are delivered to each of the control valves through a series of cables over distances that may exceed 150 feet.

It may be desirable to upgrade existing legacy control valves of a test station. However, such upgrades may not be supported by the existing legacy cables used by the test station. As a result, such a control valve upgrades may additionally require the costly replacement of the legacy cables.

### SUMMARY

Embodiments of the present disclosure relate to an adapter for connecting to a test station control valve configured to control a fluid flow through a hydraulic actuator, an assembly that includes the adapter, and a test station that includes the adapter. The adapter facilitates connections between a legacy cable and the control valve.

One example of the adapter includes a control input, a control output, a power input, and a first power output. The control input is configured to receive a valve control signal, and the control output is coupled to the control input and is configured to connect to a valve control input of the control valve. The power input is configured to receive electrical power from a power source, and the first power output is coupled to the power input and is configured to connect to a valve power input of the control valve. Embodiments of the adapter also include a fuse connected in line between the power input and the first power output, a position input configured to connect to a valve position output of the control valve and a position output coupled to the position input, and/or an enable/disable input and an enable/disable output.

An example of the assembly includes an adapter and a control valve. The adapter includes a control input, a control output, a power input, and a first power output. The control input is configured to receive a valve control signal, and the control output is coupled to the control input. The power input is configured to receive electrical power from a power source, and the first power output is coupled to the power input. Embodiments of the adapter also include a fuse connected in line between the power input and the first power output, a position input configured and a position output coupled to the position input, and/or an enable/disable input and an enable/disable output. The control valve includes a valve control input connected to the control output, and a valve power input connected to the first power output.

One example of the test station of a dynamic testing system includes a hydraulic actuator configured to drive an actuation of a test subject using a hydraulic fluid flow, a test station controller configured to transmit a control signal through a control cable based on a test program, a power source configured to supply electrical power, an adapter and a control valve. The adapter includes a control input coupled to the control cable and configured to receive the control signal from the test station controller, a control output coupled to the control input, a power input configured to receive electrical power from the power source, and a first power output coupled to the power input. Embodiments of the adapter also include a fuse connected in line between the power input and the first power output, a position input and a position output, and/or an enable/disable input and an enable/disable output. The control valve includes a valve housing, a valve body contained within the housing and having a position that controls a flow rate and direction of the hydraulic fluid flow, a valve control input coupled to the control output, a valve power input coupled to the first power output, and a valve controller configured to control the position of the valve body based on the control signal received at the valve control input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an example of a dynamic testing system, in accordance with embodiments of the present disclosure.

FIGS. 2 and 3 are schematic diagrams of an example of a test station, in accordance with embodiments of the present disclosure.

FIG. 4 is a simplified diagram of an adapter connecting a control valve to a legacy cable, in accordance with embodiments of the present disclosure.

FIG. 5 is a simplified diagram of an example of an assembly comprising an example of the adapter connected to a control valve, in accordance with embodiments of the present disclosure.

FIG. 6 is a simplified diagram of an example of a controller, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Functions recited herein may be performed by a single controller, multiple controllers, or at least one controller. As used herein, when one or more functions are described as being performed by “a controller,” such as a specific controller, one or more controllers, or at least one controller, embodiments include the performance of the function(s) by a single controller or processor or multiple controllers or processors, unless otherwise specified. Furthermore, as used herein, when multiple functions are performed by at least one controller, all of the functions may be performed by a single controller, or some functions may be performed by one controller and other functions may be performed by another controller. Thus, the performance of one or more functions by at least one controller does not require that all of the functions are performed by each of the controllers.

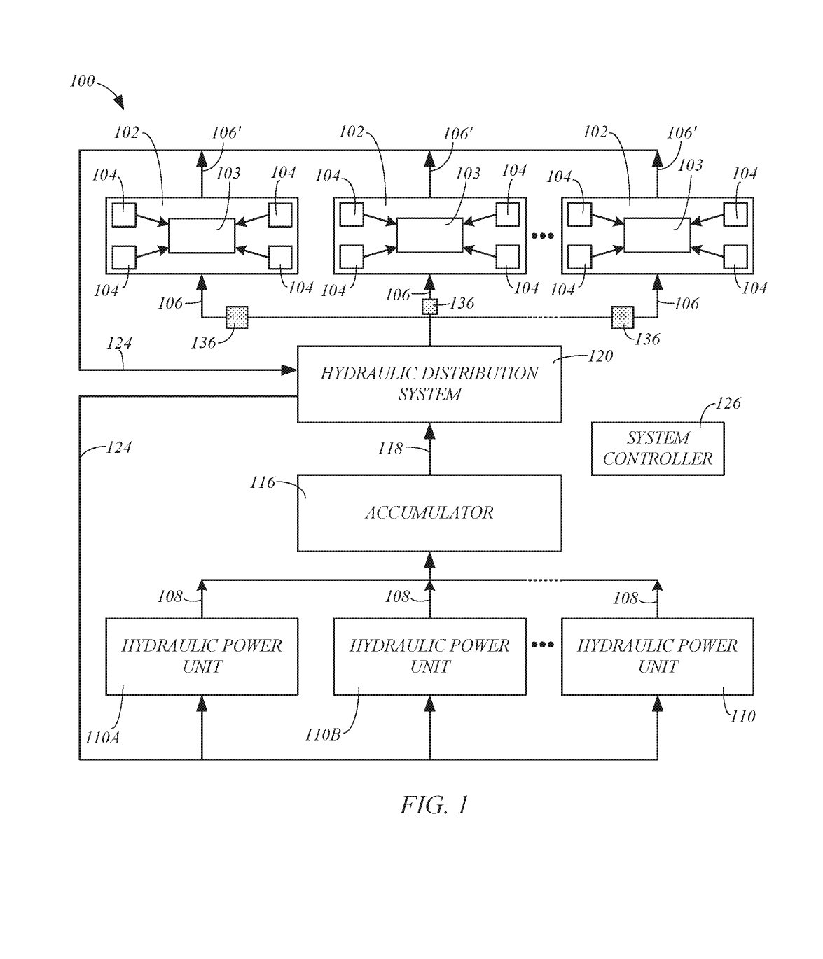

FIG. 1 is a simplified diagram of an example of a dynamic testing system 100, in accordance with embodiments of the present disclosure. The testing system 100 may include one or more test stations 102, each of which may be configured to perform a test or conditions simulation through the application of forces and/or displacements to a test subject 103 (e.g., an automobile, a building, etc.) using hydraulic actuators 104, which are driven by flows 106 of hydraulic fluid.

The flows 106 may be provided based on hydraulic fluid flows 108 generated by one or more hydraulic power units (HPU’s) 110. The system 100 may include an accumulator 116 that stores pressurized hydraulic fluid received from the HPU’s 110 and discharges a hydraulic fluid flow 118 that may be used to form the flows 106 supplied to the test stations 102. The system 100 may include a distributor 120 that receives the hydraulic fluid flows from the HPU’s 110 and/or the accumulator 116 and distributes the flows 106 of hydraulic fluid to the test stations 102. Other configurations of the system 100 may be used to supply the test stations 102 with the demanded hydraulic fluid flows 106.

The system 100 may be a closed system, in which the low pressure hydraulic fluid flows 106’ discharged from the test stations 102 are returned, such as a combined return flow 124 through the hydraulic distribution system 120 back to the HPU’s 110, for example.

A system controller 126 may operate to control various aspects of the system 100 including functions of the HPU’s 110, valving (e.g., valving of the accumulator and/or distributor) and/or other aspects of the system 100 to supply the test stations 102 with the demanded hydraulic fluid flows 106.

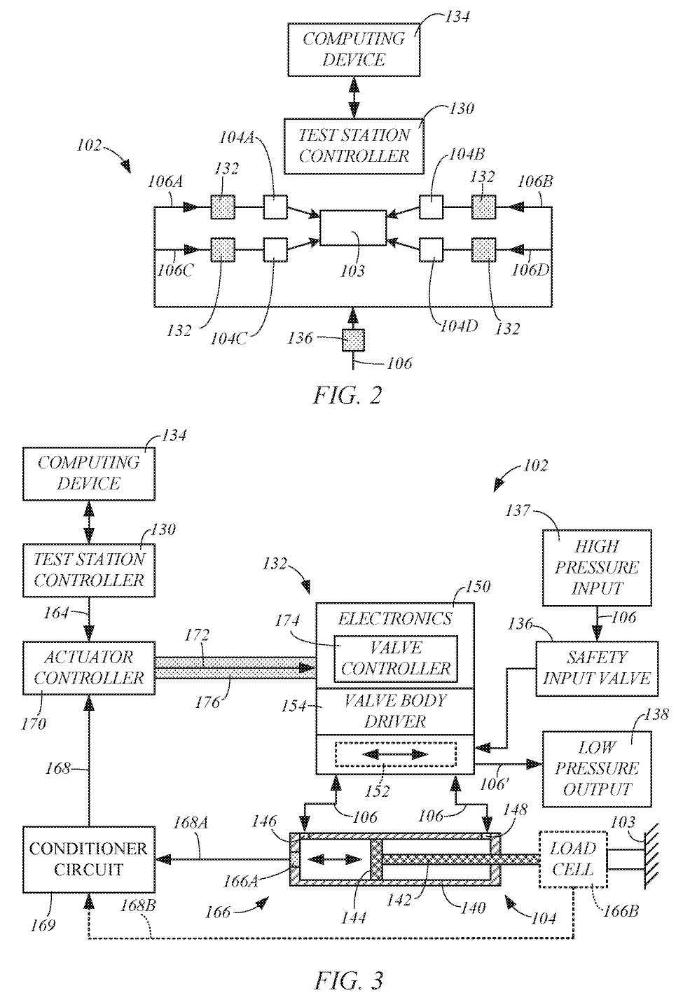

FIG. 2 is a schematic diagram of an example of a test station 102, in accordance with embodiments of the present disclosure. As mentioned above, the test station 102 includes a plurality of hydraulic actuators 104, such as hydraulic actuators 104A-D, that are configured to apply a force and/or drive a motion to the test subject 103. Each of the hydraulic actuators 104A-D is driven by a corresponding flow portion 106A-D of the hydraulic fluid flow 106 that is generated by one or more of the hydraulic power units 110 (FIG. 1).

Each test station 102 may include a test station controller 130, which is generally configured to perform a test on the test subject 103 based on the execution of a test program stored in a non-transitory computer-readable medium, for example. The test station controller 130 controls the actuators 104 to apply forces and/or motions in a conventional manner to the test subject 103 in response to the execution of the test program through the control of the hydraulic fluid flows 106A-D using corresponding control valves 132.

A computing device 134 may be configured to generate a graphical user interface through which a user may interact with and/or control the test station 102, the execution of a test program, view data, and/or perform other tasks, such as through a series of communications with the test station controller 130, for example.

One or more safety input valves 136, such as solenoid valves, may control the high pressure hydraulic fluid flow 106 input to the test stations 102, such as in response to a control signal from the test station controller 130, the system controller 126, or another suitable device (e.g., emergency stop), for example. Each safety input valve 136 has a fully opened state that provides a mostly unrestricted pathway for the hydraulic fluid flow 106 to travel to the test station 102. The valve 136 also has a closed or substantially closed state, in which the valve 136 blocks or substantially blocks the hydraulic fluid flow 106 to the test station 102. The solenoid of the valve 136 may have a default or deenergized state corresponding to the closed or substantially closed state.

FIG. 3 is a simplified diagram of an example of a test station 102, in accordance with embodiments of the present disclosure. As discussed above, the test station 102 includes a test station controller 130 and at least one hydraulic actuator 104 and its corresponding control valve 132. While only a single hydraulic actuator 104 and control valve 132 pair is shown in FIG. 3 to simplify the illustration, it is understood that the test station 102 may include two or more actuators 104 and corresponding control valves 132, as indicated in FIG. 2.

The control valve 132 for each hydraulic actuator 104 operates to control a flow rate (e.g., gallons per minute) of the flow 106 of hydraulic fluid to the actuator 104 that is received from a high pressure source 137 (e.g., one or more of the HPUs 110 or the accumulator 116), and to discharge the flow 106’ to a low pressure reservoir 138 (e.g., return to reservoir of HPU 110). Additionally, the control valve 132 controls the direction of the flow through the hydraulic actuator 104 to control the actuation that is applied to the test subject 130.

In one example, the hydraulic actuator 104 includes a cylinder 140 and an actuator rod 142 having a piston 144 that is contained within the cylinder 140. The cylinder 140 includes first and second ports 146 and 148, through which the flow 106 of hydraulic fluid travels. The valve 132 controls the direction of the hydraulic fluid flow 106 through the first and second ports 146 and 148 to control the direction of movement of the actuator rod 142, and the flow rate of the hydraulic fluid flow 106, which controls the speed at which the actuator rod 142 moves relative to the cylinder 140.

The control valve 132 may take on any suitable form. Examples of the control valve 132 include servo valves or solenoid valves that are configured to provide the variable flow rate and direction control described above. As indicated in FIG. 3, the control valve 103 generally includes electronics 150, a valve body 152 and a valve body driver 154. The valve body 152 has an adjustable position that controls the direction and flow rate of the hydraulic fluid flow 106. For example, the valve body 152 may take the form of a spool and the valve body driver 154 may take the form of a servo. An example of this type of control valve 132 is described in U.S. Publication No. 2016/0123355. The electronics 150 are configured to control the valve body driver 154 to adjust the position of the valve body 152 in response to an actuator command signal 156.

During the execution of a test program, the test station controller 130 issues reference signals 164 relating to desired actuations that are to be performed by the hydraulic actuators 104 on the test subject 103. Each actuator 104 includes an actuation sensor 166 that is configured to sense a parameter of the actuation performed by the actuator 104, such as a displacement and/or a force, and issues a feedback signal 168 that is indicative of the sensed parameter. The actuation sensor 166 may comprise, for example, a displacement sensor 166A, such as a linear variable differential transformer that is configured to detect a displacement and/or movement of the actuator rod 142 relative to the cylinder 140 and produce a feedback signal 168A that is indicative of the detected displacement and/or movement, and/or a load cell 166B that is configured to detect a force applied by the actuator 104, such as to the test subject 103, and produce a feedback signal 168B that is indicative of the detected force, as indicated in FIG. 3. A conventional conditioner circuit 169 may be used to process the signals 168A and/or 168B (e.g., amplify, filter, etc.) to produce the final feedback signal 168.

An actuator controller 170 is configured to compare the reference signals 164 and the feedback signal 168 corresponding to each actuator 104 and issue a differential signal 172 for the corresponding control valve 132. The control valve 132 electronics, such as a valve controller 174, adjusts the flow rate and/or flow direction of the fluid flow 106 to produce the desired actuation, based on the differential signal 172. While the actuator controller 170 is illustrated in FIG. 3 as receiving a single reference signal 164 and issuing a single differential signal 156 corresponding to the depicted actuator 104, the actuator controller 170 may be configured to receive multiple reference signals 164 from the test station controller 130 for each hydraulic actuator 104 of the test station 102, and issue differential signals 172 to control the corresponding valves 132.

Test stations 102 have been in use for many years and may utilize legacy control valves 132, which are controlled through the transmission of the differential signals 172 and power through a corresponding legacy control cable 176, as indicated in FIG. 3. For example, when the control valve is a 252 Series Servovalve produced by MTS Systems Corporation, the legacy cable 176 may take the form of a shielded multi-conductor transmission cable that supplies the required analog current drive control signal and power (e.g., +/- 250 mA) required by the legacy control valve.

Newer control valves, such as the 255 Series Servovalve produced by MTS Systems Corporation, servo proportional valves (e.g., SxPRO) produced by Domin, and other modern control valves, are generally incompatible with such legacy cables 176 that are in use with many existing test stations 102. For example, the legacy cable 176 may be unable to fully connect to modern control valves (e.g., fewer pins), may be unable to supply the required signals or power, and/or may be unsuitable for other reasons. As a result, when a test station 102 is upgraded with newer control valves, the legacy cables 176 must generally be replaced with updated cables. This can be a complicated and costly process due to the length and location of the cables 176 within the test station 102, which generally discourages control valve upgrades.

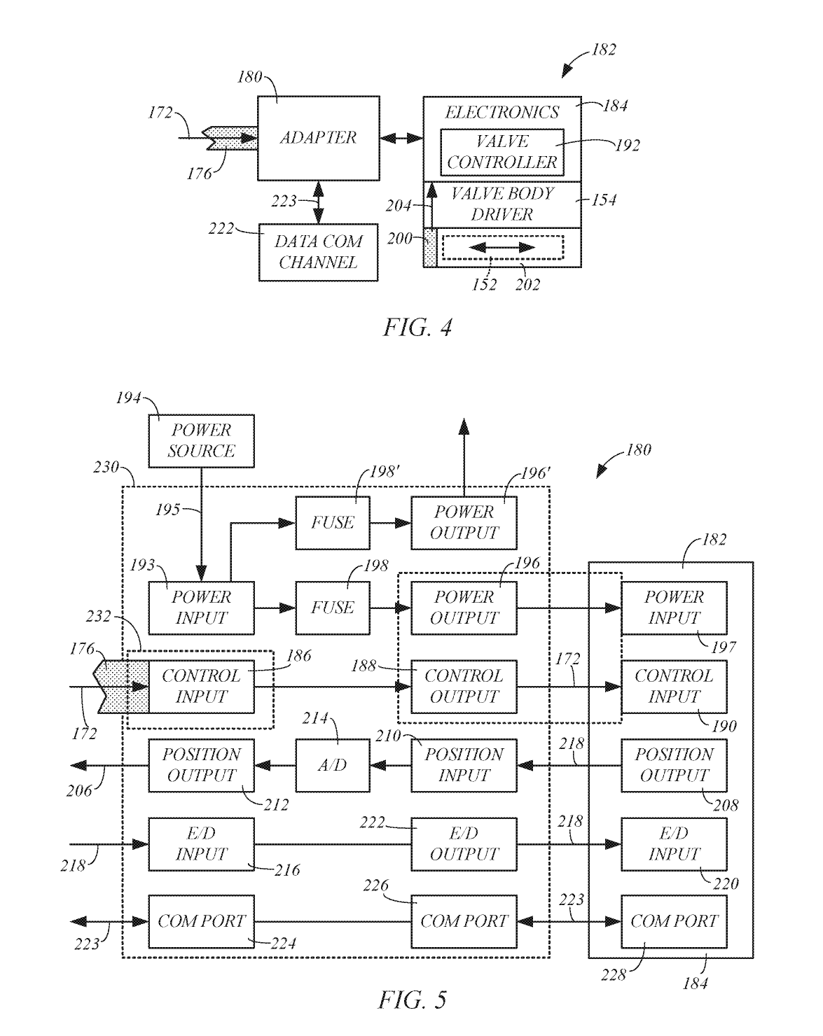

Embodiments of the present disclosure relate to an adapter that allows for upgrades to legacy control valves 132 without having to upgrade the corresponding legacy cables 176. As indicated in the simplified diagram of FIG. 4, the adapter 180 is generally configured to connect between the legacy cable 176 and a control valve 182, which may take the form of an upgraded, modern control valve having unique functions and input and output features relative to the legacy control valve 132. Thus, the control valve 182 may replace one or more of the control valves 132 in the test station 102 shown in FIG. 2 and operate to control the flows 106 to one or more of the actuators 104.

The control valve 182 may include similar features to the legacy control valve 132, such as the valve body 152 and the valve body driver 154, that operate in a similar manner to the corresponding components of the legacy control valve 132. The control valve 182 also includes electronics 184 that may be configured to perform similar functions as the electronics 150 of the legacy control valve 132. However, the electronics 184 may have different inputs and/or outputs and be configured to perform functions that are not performed by the electronics 150 of the legacy control valve 132.

FIG. 5 is a simplified diagram of an example of an assembly comprising an example of the adapter 180 connected to a control valve 182, in accordance with embodiments of the present disclosure. The illustrated inputs and outputs may take on any suitable form, each of which may be housed in a suitable connector.

In some embodiments, the adapter 180 includes a control input 186 that receives the control signal 172 from the legacy cable 176, and a control output 188, through which the control signal 172 is supplied to the control valve 182, such as at a control input 190. The electronics 184 of the control valve 182, such as a valve controller 192, are configured to control the valve body 152 as described above based on the control signal 172.

In some embodiments, the control valve 182 has different power requirements than that of the legacy control valve 132. The adapter 180 may include a power input 193 that may be coupled to a suitable power source 194 and configured to supply the required power. A power feed 195 received at the power input 193 is fed to a power output 196 that may be connected to a power input 197 of the valve electronics 184. In one example, the power source 194 provides a power feed 195 of 24 VDC and a current of up to 2.0 Amps, and may power other components of the test station 102, such as other adapters 180, for example.

In one embodiment, the adapter 180 includes a fuse 198 that is positioned in series between the power input 188 and the power output 194. The fuse 198 is configured to trip in response to a transient power surge to protect the valve electronics 184.

The adapter 180 may include one or more additional power inputs 188 and/or power outputs 194. For example, the adapter 180 may include a second power output 196’ that is connected to the power input 193, as shown in FIG. 5, or connected to a separate power input (not shown). A fuse 198’ may be used to provide transient power surge protection to any component that receives power through the power output 196’.

In some embodiments, the control valve 182 includes a position sensor 200 that is configured to detect the position of the valve body 152, such as relative to a housing 202 of the valve 182, and output a sensor signal 204 that is indicative of the detected position, as indicated in FIG. 4. The electronics 184, such as the valve controller 192, are configured to generate a position signal 206 based on the sensor signal 204 that is indicative of the detected position of the valve body 152. The position signal 206 may be conducted through a position output 208 of the valve 182, and received by the adapter 180 at a position input 210. The position signal 206 may be fed to a position output 212 of the adapter 180, which may be coupled to the test station controller 130 (FIG. 2) or another controller of the test station 102.

In one embodiment, the position signal 206 conducted through the position output 208 is an analog signal having a voltage that represents the position of the valve body 152, and the adapter 180 includes an analog-to-digital (A/D) converter 214 that converts the analog position signal into a digital signal, which is then fed to the position output 212. The A/D converter 214 may be powered using power received at one of the power inputs 188 of the adapter 180.

In some embodiments, the control valve 182 includes an enable/disable (E/D) input 216 that receives an E/D signal 218, such as from the test station controller 130, or another controller of the test station 102, as indicated in FIG. 5. The E/D signal 218 is delivered from the input 216 to an E/D input 220 of the control valve 182 through an E/D output 222 of the adapter 180. When the E/D signal 218 has a first state (e.g., logic low voltage), the electronics 184 or valve controller 192 disables the valve body driver 154 from moving the valve body 152 relative to the housing 202, and when the E/D signal 218 has a second state (e.g., logic high voltage), the electronics 184 or valve controller 192 allows the valve body driver 154 to adjust the position of the valve body 152 based on the control signal 172.

The adapter 180 may also be configured for connection to a data communications channel 222 (e.g., Ethernet for Control Automation Technology (EtherCAT®), controller area network (CAN), etc.) used by the test station 102 to communicate data 223, as indicated in FIG. 4. The adapter 180 may include a communications port 224 that connects to the data communications channel 222, and a communications port 226, to which a component of the test station 102 may connect, such as a communication port 228 of the valve electronics 184, as indicated in FIG. 5.

The adapter 180 may comprise a housing 230 supporting and/or enclosing its components. Each of the inputs (e.g., control input 186, power input 193, etc.), outputs (e.g., position output 212) and communication ports (e.g., communications ports 224 and 226) may have a corresponding connector, or one or more of the inputs, outputs, and ports of the adapter 180 may be grouped together in a single connector. The housing 230 may also include one or more cables having connectors that support one or more of the inputs, outputs and/or ports of the adapter 180.

For example, the housing 230 may include a connector 232 that includes the control input 186 that facilitates connection to the legacy cable 176, as indicated in FIG. 5. The adapter housing 230 may also include a connector 234 that comprises the control output 188 and the power output 196 and is configured to couple to the control input 190 and the power input 197 of the valve electronics 184. The housing 230 may include a cable that comprises the connector 232 to simplify the connection with the cable 176 and/or a cable that comprises the connector 234 to simplify its connection to the valve 182.

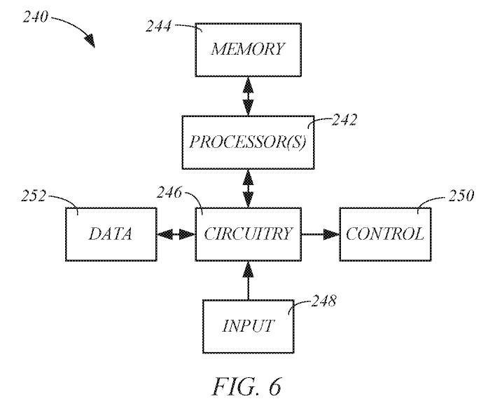

The controllers of the system 100, such as the system controller 126, the test station controller 130, the actuator controller 170, the valve controllers 174 and 192, etc., may take on any suitable form to provide the various functions described herein, such as that of the example controller 240 shown in FIG. 6. The controller 240 may include one or more processors 242 and memory 244. The one or more processors 242 are configured to perform various functions described herein in response to the execution of instructions contained in the memory 244, such as a test program, for example.

The one or more processors 242 may be components of one or more computer-based systems, and may include one or more control circuits, microprocessor-based engine control systems, and/or one or more programmable hardware components, such as a field programmable gate array (FPGA). The memory 244 represents local and/or remote memory or computer readable media. Such memory 244 comprises any suitable patent subject matter eligible computer readable media and does not include transitory waves or signals. Examples of the memory 244 include conventional data storage devices, such as hard disks, CD-ROMs, optical storage devices, magnetic storage devices and/or other suitable data storage devices. The controller 240 may include circuitry 246 for use by the one or more processors 242 to receive input signals 248, issue control signals 250 and/or communicate data 252, such as in response to the execution of the instructions stored in the memory 244 by the one or more processors 242.

Although the embodiments of the present disclosure have been described with reference to preferred embodiments, workers skilled in the art will recognize that changes may be made in form and detail without departing from the spirit and scope of the present disclosure.

What is claimed is:

1. An adapter for connecting to a test station control valve, which is configured to control a fluid flow through a hydraulic actuator, the adapter comprising:
a control input configured to receive a valve control signal;
a control output coupled to the control input and configured to connect to a valve control input of the control valve;
a power input configured to receive electrical power from a power source;
a first power output coupled to the power input and configured to connect to a valve power input of the control valve; and
at least one of:
a fuse connected in line between the power input and the first power output;
a position input configured to connect to a valve position output of the control valve and a position output coupled to the position input; and
an enable/disable input and an enable/disable output.

2. The adapter according to claim 1, wherein the adapter includes the fuse.

3. The adapter according to claim 1, wherein the adapter includes the position input and the position output.

4. The adapter according to claim 1, wherein the adapter includes the enable/disable input and the enable/disable output.

5. The adapter according to claim 3, further comprising an analog to digital converter connected in line between the position input and the position output and configured to convert an analog signal received at the position output to a digital signal, which is delivered to the position output.

6. The adapter according to claim 1, wherein the control output and the first power output are housed in a single connector.

7. The adapter according to claim 1, further comprising a housing enclosing couplings between the control input and the control output, and the power input and the first power output.

8. The adapter according to claim 1, wherein the control input is configured to couple to a controller area network (CAN) bus or Ethernet for control automation technology (EtherCAT).

9. The adapter according to claim 1, further comprising a second power output coupled to the power input.

10. An assembly comprising:
an adapter comprising:
a control input configured to receive a valve control signal;
a control output coupled to the control input;
a power input configured to receive electrical power from a power source;
a first power output coupled to the power input; and
at least one of:
a fuse connected in line between the power input and the first power output;
a position input and a position output; and
an enable/disable input and an enable/disable output; and
a control valve including:
a valve control input connected to the control output; and
a valve power input connected to the first power output.

11. The assembly according to claim 10, wherein the adapter includes the fuse.

12. The assembly according to claim 10, wherein:
the adapter includes the position input and the position output; and
the control valve includes a valve position output connected to the position input of the adapter.

13. The assembly according to claim 10, wherein:
the adapter includes the enable/disable input and the enable/disable output; and
the control valve includes a valve enable/disable input that is connected to the enable/disable output of the adapter.

14. The assembly according to claim 10, wherein the control output and the first power output are housed in a single connector.

15. The assembly according to claim 10, wherein the control valve includes:
a valve housing;
a valve body contained within the housing and having a position that controls a flow rate and direction of a hydraulic fluid flow; and
a valve controller configured to control the position of the valve body based on the control signal received at the valve control input.

16. A test station of a dynamic testing system comprising:
a hydraulic actuator configured to drive an actuation of a test subject using a hydraulic fluid flow;
a test station controller configured to transmit a control signal through a control cable based on a test program;
a power source configured to supply electrical power;
an adapter comprising:
a control input coupled to the control cable and configured to receive the control signal from the test station controller;
a control output coupled to the control input;
a power input configured to receive electrical power from the power source;
a first power output coupled to the power input; and
at least one of:
a fuse connected in line between the power input and the first power output;
a position input and a position output; and
an enable/disable input and an enable/disable output; and
a control valve including:
a valve housing;
a valve body contained within the housing and having a position that controls a flow rate and direction of the hydraulic fluid flow;
a valve control input coupled to the control output;
a valve power input coupled to the first power output; and
a valve controller configured to control the position of the valve body based on the control signal received at the valve control input.

17. The test station according to claim 16, wherein the adapter includes the fuse.

18. The test station according to claim 16, wherein:
the adapter includes the position input and the position output; and
the control valve includes a valve position output connected to the position input of the adapter.

19. The test station according to claim 16, wherein:
the adapter includes the enable/disable input and the enable/disable output; and
the control valve includes a valve enable/disable input that is connected to the enable/disable output of the adapter.

20. The test station according to claim 16, wherein the control output and the first power output are housed in a single connector that is configured to attach to the control cable.
